(19) United States
(12) Patent Application Publication
(10) Pub. No.: US 2026/0349431 A1
(43) Pub. Date: Nov. 5, 2026

(54) MAP UPDATING METHOD, AUTONOMOUS MOVING APPARATUS AND STORAGE MEDIUM

(71) Applicants: KUKA Robotics Guangdong Co., Ltd., Foshan (CN); GD Midea Air-Conditioning Equipment Co., Ltd., Foshan (CN); MIDEA GROUP CO., LTD., Foshan (CN)

(72) Inventors: Fan Yang, Foshan (CN); Xiaoliang Jiao, Foshan (CN); Wei Xi, Foshan (CN); Ming Chen, Foshan (CN)

(21) Appl. No.: 19/560,122

(22) Filed: Mar. 8, 2026

Related U.S. Application Data
(63) Continuation of application No. PCT/CN2023/117743, filed on Sep. 8, 2023.

(51) Int. Cl. G05D 1/246; G05D 109/10; G05D 111/10

(52) U.S. Cl. CPC G05D 1/2464; G05D 1/2462; G05D 2109/10; G05D 2111/17

(57) ABSTRACT

Provided are a map updating method, an autonomous moving device and a storage medium. A pre-constructed global map, a semantic map, and a pose and sensor data of an autonomous mobile device are acquired, where in the semantic map, a static region and a dynamic region of the global map are labeled. A local map is periodically constructed based on the pose and the sensor data, the periodically constructed local map having a limited coverage range. A target local map aligned with the global map is obtained by aligning the global map with the local map. The global map is updated based on the global map, the semantic map, and the target local map.

### CROSS-REFERENCE OF RELATED APPLICATION

This application is a continuation of International Application No. PCT/CN2023/117743 filed Sep. 8, 2023, the entire disclosures of which are incorporated herein by reference.

### TECHNICAL FIELD

Embodiments of the disclosure relate to the field of autonomous navigation technologies, and particularly to a map updating method, an autonomous mobile device, and a storage medium.

### BACKGROUND

Simultaneous localization and mapping (SLAM) technology is one of the key technologies enabling autonomous navigation for autonomous mobile devices, aiming to solve the problems of localization and map construction. SLAM is a process in which a mobile device equipped with specific sensors (such as a LiDAR, an inertial measurement unit, or a camera) constructs an environmental model during movement, while simultaneously estimating states such as its own position, pose, and trajectory without prior environmental knowledge. The model used to describe an environment is a map, which may be categorized into a metric map and a topological map. The metric map, such as a raster map, a point cloud map, or a QR code map, emphasizes a spatial relationship between objects within the map, and it is commonly used for localization and small-scale route planning. The topological map emphasizes a relationship between map elements while disregarding actual physical dimensions, and it is commonly used for large-scale path planning.

Currently, one of the challenges in the autonomous navigation technology is that the complex industrial environment in which the autonomous mobile device operates is not static and unchanging. The dynamic object commonly found in the complex industrial environment would cause changes in the local environments. Since a localization system obtains a pose in a global map by performing matching based on sensor data and the global map, the changes in the local environment would lead to inconsistency between the map used by the localization system and an actual working environment. This would result in a reduction in the reliability of the estimated pose. The environment change conditions may be categorized into short-term transient changes and long-term gradual changes, according to a time period (scale) of the changes. Specifically, the short-term transient changes may include, but are not limited to, a moving vehicle and person in a human-robot coexistence space, etc. Such short-term transient changes only affect the accuracy of localization when the moving object enters the coverage range of the sensor of the autonomous mobile device. The long-term gradual changes may include, but are not limited to, shelf relocation and layout modification, etc. Unlike the short-term transient changes, the long-term gradual changes usually do not occur during the operation or within the coverage range of the autonomous mobile device.

Related technologies take a method of periodically reconstructing an entire environment to update a global map. In this way, the states of dynamic objects are only updated when the map is constructed, while the dynamic objects in the environment have different change cycles. When an update cycle is long, the dynamic objects with short change cycles may not be updated in the map in a timely manner. When the map update cycle is shortened, the operation cost would increase, affecting the normal operation of other units. The efficiency of mapping is low, and it takes a considerable amount of time to construct a map for a large range. In other words, the existing map updating methods suffer from low update efficiency and poor consistency.

### SUMMARY

The embodiments of the disclosure provide a map updating method, an autonomous mobile device, and a storage medium.

In a first aspect, some embodiments of the disclosure provide a map updating method. The method includes: acquiring a pre-constructed global map, a semantic map, and a pose and sensor data of an autonomous mobile device, where in the semantic map, a static region and a dynamic region of the global map are labeled; periodically constructing a local map based on the pose and the sensor data, the periodically constructed local map having a limited coverage range; obtaining, by aligning the global map with the local map, a target local map aligned with the global map; and updating the global map, based on the global map, the semantic map, and the target local map.

In another aspect, some embodiments of the disclosure provide an autonomous mobile device. The autonomous mobile device includes a memory and a processor, and the memory stores an application program which, when being invoked by the processor, causes the method according to the embodiments of the disclosure to be implemented.

In yet another aspect, some embodiments of the disclosure provide a computer readable storage medium. The computer readable storage medium stores program codes which, when being executed by a processor, cause the processor to execute the method according to the embodiments of the disclosure.

### BRIEF DESCRIPTION OF THE DRAWINGS

In order to clearly illustrate technical solutions in the embodiments of the disclosure, drawings to be used in the embodiments are briefly described below. Apparently, the following described drawings are merely some embodiments of the disclosure, rather than all embodiments. Based on the embodiments of the disclosure, all other embodiments and drawings obtained by those of ordinary skill in the art without creative efforts shall fall within the protection scope of the disclosure.

FIG. 1 is a structural block diagram of an autonomous mobile device according to an embodiment of the disclosure.

FIG. 2 is a flowchart of a map updating method according to an embodiment of the disclosure.

FIG. 3 is a flowchart of a map updating method according to another embodiment of the disclosure.

FIG. 4 is a schematic diagram illustrating a semantic map according to an exemplary embodiment of the disclosure.

FIG. 5 is a flowchart of S120 in FIG. 3 according to an embodiment of the disclosure.

FIG. 6 is a schematic diagram illustrating a pose graph according to an exemplary embodiment of the disclosure.

FIG. 7 is a schematic diagram illustrating a global map according to an exemplary embodiment of the disclosure.

FIG. 8 is a schematic diagram illustrating a partial process of constructing a local map according to an exemplary embodiment of the disclosure.

FIG. 9 is a schematic diagram illustrating a partial process of constructing the local map according to another exemplary embodiment of the disclosure.

FIG. 10 is a schematic diagram illustrating a partial process of constructing the local map according to yet another exemplary embodiment of the disclosure.

FIG. 11 is a schematic diagram illustrating a partial process of constructing the local map according to still another exemplary embodiment of the disclosure.

FIG. 12 is a flowchart of aligning the local map and a global map according to an exemplary embodiment of the disclosure.

FIG. 13 is a flowchart of S140 in FIG. 3 according to an embodiment of the disclosure.

FIG. 15 is a schematic diagram illustrating a global map according to yet another exemplary embodiment of the disclosure.

FIG. 16 is a partial flowchart of the map updating method according to another embodiment of the disclosure.

FIG. 17 is a flowchart of the map updating method according to an exemplary embodiment of the disclosure.

FIG. 18 is a structural block diagram of a map updating apparatus according to an embodiment of the disclosure.

FIG. 19 is a structural block diagram of an autonomous mobile device according to another embodiment of the disclosure.

### DETAILED DESCRIPTION OF PREFERRED EMBODIMENTS

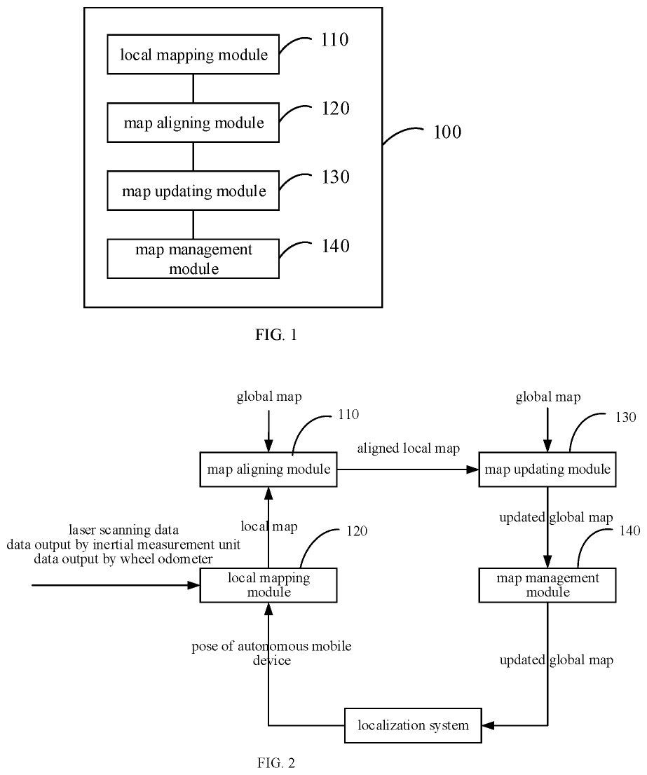

FIG. 1 is a structural block diagram of an autonomous mobile device according to an embodiment of the disclosure. The autonomous mobile device 100 may include, but is not limited to, an autonomous mobile robot (AMR) or an automated guided vehicle (AGV). The autonomous mobile device 100 may include a local mapping module 110, a map aligning module 120, a map updating module 130, and a map management module 140.

As illustrated in FIG. 2, FIG. 2 is a flowchart of a map updating method according to an embodiment of the disclosure. The local mapping module 110 is configured to construct a local map, based on data output by a light detection and ranging (LiDAR), an inertial measurement unit (IMU), a wheel odometer, and a camera, and based on a pose output by a localization system of the autonomous mobile device 100. The local mapping module 110 may send the local map to the map aligning module 120 via robot operating system (ROS) communication or remote procedure call (RPC), where the RPC may be Google remote procedure call (gRPC). The map aligning module 120 is configured to align the local map with the global map. The map updating module 130 is configured to update the global map based on the local map that has been aligned with the global map. The map management module 140 is configured to manage historical global maps and updated global maps, and output the updated global map to the localization system of the vehicle, so that the localization system may determine the pose of the autonomous mobile device 100 based on the updated global map.

In the embodiments of the disclosure, the local mapping module 110 is configured to execute S110 to S120 described below. The map aligning module 120 is configured to execute S130 described below. The map updating module is configured to execute S140 described below. The map management module 140 is configured to execute S210 to S230 described below.

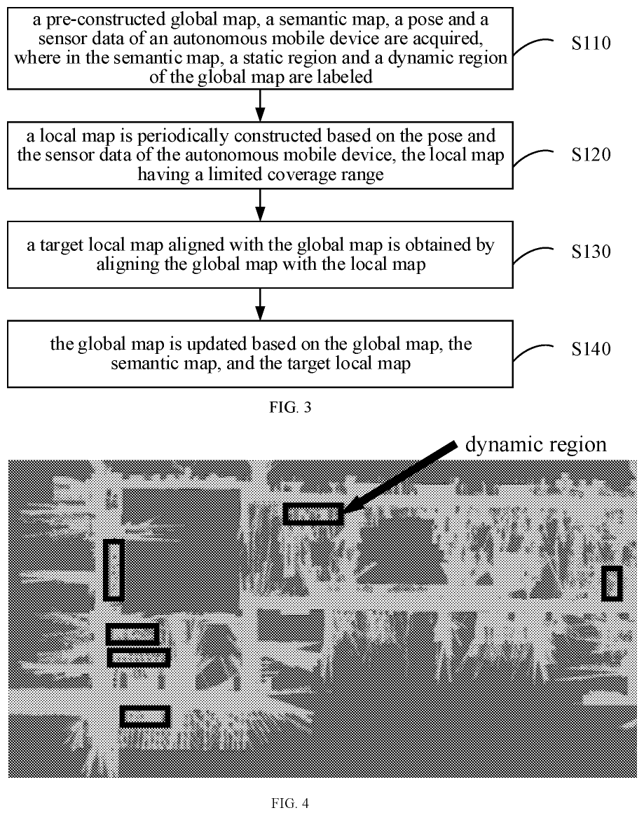

FIG. 3 is a flowchart of a map updating method according to another embodiment of the disclosure. The map updating method may be implemented by the autonomous mobile device or a map updating apparatus. The map updating method may include S110 to S140 as follows.

At S110, a pre-constructed global map, a semantic map, and a pose and sensor data of an autonomous mobile device are acquired, where in the semantic map, a static region and a dynamic region of the global map are labeled.

Generally, before working, the autonomous mobile device takes a SLAM method to comprehensively map an actual operation scenario of the autonomous mobile device, thereby generating a global map, which facilitates subsequent autonomous navigation based on the global map. The global map may include an obstacle, such as a wall, a corridor, and/or a shelf, in the actual operation scenario obtained through SLAM.

In the embodiments of the disclosure, the semantic map is annotated with the static region and the dynamic region in the global map. The dynamic region refers to a region where a dynamic object of low change cycle (which may also be referred to as a low-dynamic object that has a short change cycle, such as a shelf and/or a pallet) is located, and the static region includes a static map element with obvious features in the global map (such as a corridor, a wall, and/or a concrete column). For example, referring to the semantic map illustrated in FIG. 4, the region within the bold rectangular box indicated by an arrow represents the dynamic region.

To improve the accuracy of map updating, it requires that the dynamic object of low change cycle is detected as comprehensively as possible, moving objects in the map are filtered out, and key features in the map are preserved. In the embodiments of the disclosure, at least two dynamic region determination methods are used to determine at least two preliminary dynamic regions in the global map, where each dynamic region determination method determines one preliminary dynamic region. An intersection of the at least two preliminary dynamic regions is calculated as a dynamic region, and the semantic map is constructed based on the dynamic region. Specifically, the at least two dynamic region determination methods may include, but are not limited to, manual annotation, static obstacle filtering, map database analysis, and map likelihood difference analysis.

The manual annotation method for determining a preliminary dynamic region is as follows. A global map is output, so that relevant personnel may manually annotate a dynamic region in the global map. The region manually annotated in the global map is acquired as a preliminary dynamic region.

The static obstacle filtering method for determining a preliminary dynamic region is as follows. A global map is output, so that relevant personnel may process the global map to only retain, in the global map, stably unchanged obstacles (e.g., a corridor, a wall, and/or a concrete pillar) of the actual operation scenario of the autonomous mobile device, and erase other changeable regions that may change. For example, relevant personnel may determine a static region in the global map based on an architectural drawing of the actual operation scenario of the autonomous mobile device, and may determine, based on a task planning of the autonomous mobile device, a region in which a shelf moves. This enables the global map including only stably unchanged obstacles to be served as a filter, thereby filtering stably unchanged obstacles in the global map. The manually processed global map is acquired. A region in the global map excluding the stably unchanged obstacles is determined as the preliminary dynamic region.

The map database analysis method for determining a preliminary dynamic region is as follows. Multiple historical global maps are acquired from a map database. For the same grid cell in the multiple historical global maps, a change curve of the grid cell is generated. Hidden Markov model (HMM) is used to model the change curve of the grid cell. A curvature of the change curve is calculated, and a region corresponding to a grid cell whose curvature is greater than a specified curvature is determined as the preliminary dynamic region. The specified curvature may be determined based on an actual accuracy requirement and the actual operation scenario of the autonomous mobile device, which is not specifically limited herein. Generally, a higher specified curvature indicates a greater degree of environmental change in the region corresponding to the grid cell.

The map likelihood difference method for determining a preliminary dynamic region is as follows. A likelihood value of the same grid cell in the local map and the global map is calculated by using a likelihood algorithm; and a region corresponding to a grid cell whose likelihood value is greater than a preset likelihood value is determined as the preliminary dynamic region. The specified likelihood value may be determined based on an actual accuracy requirement and the actual operation scenario of the autonomous mobile device, which is not specifically limited herein. Generally, a higher specified likelihood value indicates a greater degree of environmental change in the region corresponding to the grid cell.

In the embodiments of the disclosure, the pose of the autonomous mobile device may be output by a LiDAR odometer or the localization system. The LiDAR odometer obtains the pose by performing continuous construction through a filtering method using data from the LiDAR, the inertial measurement unit, the wheel odometer, and the camera. The filtering method may be any existing filtering method, which is not limited herein. The pose output by the LiDAR odometer is calculated based on the data output by the LiDAR, the inertial measurement unit, the wheel odometer, and the camera, and it has a certain cumulative error that increases over time.

The autonomous mobile device is installed with a sensor for perceiving surrounding environment information of the autonomous mobile device. Data detected by the sensor is referred to as sensor data, and the specific content of the sensor data is determined by the actual sensor installed on the autonomous mobile device. In the embodiments of the disclosure, the sensor data at least includes laser scanning data.

At S120, a local map is periodically constructed based on the pose and the sensor data, and the periodically constructed local map has a limited coverage range.

During the movement of the autonomous mobile device, a pose graph may be constructed based on the pose output by the LiDAR odometer and the sensor data. The local map is constructed and released based on the pose graph, when a pre-set condition for periodically releasing a local map is met. In the embodiments of the disclosure, the coverage range of the periodically released local map is limited by constructing the local map based on the pose graph and limiting the number of nodes in the pose graph, thereby reducing the cumulative error and improving the accuracy of map updating.

Specifically, during the movement of the autonomous mobile device, one local map is constructed and released each time the condition for periodically releasing the local map is met. In the embodiments of the disclosure, each release of the local map together with all preceding steps thereof define one cycle of local map construction. The following describes the method of constructing the local map for one cycle.

Referring to FIG. 5, the method of constructing the local map for one cycle in S120 may include S121 to S123.

At S121, each time one pose and one frame of sensor data of the autonomous mobile device are acquired, a pose graph is constructed in real-time based on the acquired pose and sensor data.

For each pose, it is taken as a current pose, and a motion filtering method may be used to detect whether the current pose meets a preset condition. Specifically, it may be determined, based on a relative motion between a current moment and a previous moment, whether the current pose meets the preset condition. For example, a pose at the previous moment may be acquired, and a distance difference and an angle difference between the current pose and the pose at the previous moment may be calculated. It is determined whether the distance difference between the current pose and the pose at the previous moment is greater than a preset distance. It is determined whether the angle difference between the current pose and the pose at the previous moment is greater than a preset angle difference. When the distance difference is greater than the preset distance and/or the angle difference is greater than the preset angle difference, it is determined that the current pose meets the preset condition. When the distance difference is less than or equal to the preset distance and the angle difference is less than or equal to the preset angle difference, it is determined that the current pose does not meet the preset condition. When the current pose meets the preset condition, the current pose is added as a node to the pose graph. When adding the pose as a node to the pose graph, a frame of laser scanning data acquired at the same time as acquiring the pose is added to the node corresponding to the pose, and there is a corresponding relationship between the pose (i.e., the node in the pose graph) and the laser scanning data that are acquired at the same time. When the current pose does not meet the preset condition, the current pose is skipped, and the current pose is not used to construct the pose graph. Motion filtering may be used to filter out redundant poses, thereby avoiding the addition of redundant nodes to the pose graph. This improves the mapping efficiency, and alleviating problems such as non-convergence or poor optimization results during subsequent pose graph optimization.

In some embodiments, for each frame of the sensor data, this sensor data is taken as current sensor data, and it may be determined whether the current sensor data includes preset reference object information. A preset reference object refers to a reference object that is previously set and placed in the actual operation scenario of the autonomous mobile device, and is used for assisting map alignment and map updating. The preset reference object does not depend on the environment and is not affected by environmental changes. The preset reference object may include, but is not limited to, a QR code, a reflector, and the like. The preset reference object information may include a pose of the preset reference object. When the current sensor data includes the preset reference object information, the pose of the preset reference object is added as a node to the pose graph. By introducing the pose of the preset reference object into the pose graph, the constraint relationship between nodes in the pose graph may be strengthened, which improves the quality of the constructed map when the environment undergoes significant changes, thereby increasing the robustness of local mapping.

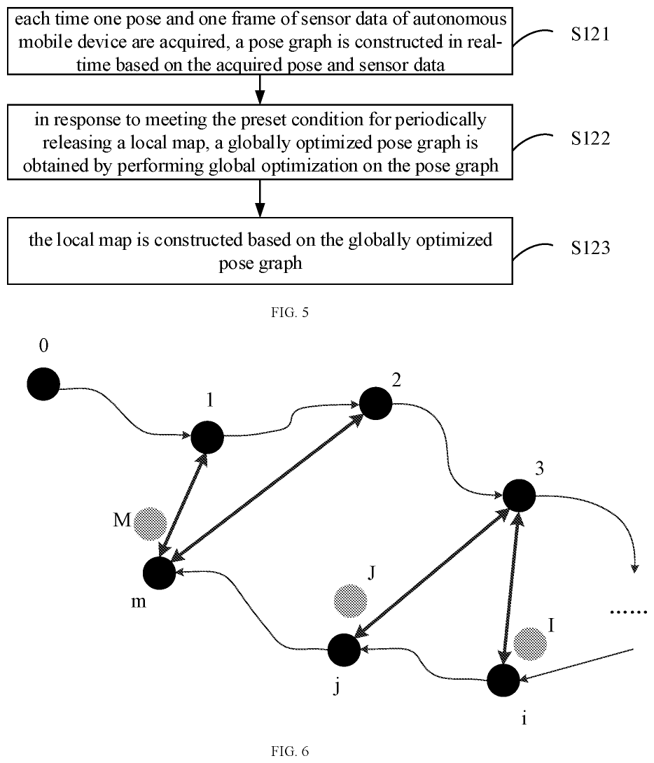

Each time one node is newly added to the pose graph, a constraint relationship of the node may be obtained, and an edge of the pose graph is constructed based on the constraint relationship. The constraint relationship of each node is a “calculated observation constraint” that is calculated by the LiDAR odometer based on the data output by the wheel odometer, the inertial measurement unit, the camera, and the LiDAR. As an example, as illustrated in FIG. 6, points 0, 1, 2, 3, . . . , i, j, and m represent nodes in the pose graph, and the unbolded single arrows represent edges connecting the nodes (i.e., edges in the pose graph). An edge in the pose graph is used to constrain two nodes connected by the edge, and represents a “calculated observation constraint” output by the LiDAR odometer. As the autonomous mobile device moves in the scenario, a cumulative error of the “calculated observation constraint” would increase, leading to a deviation from the “actual observation constraint” output by the LiDAR. As illustrated in FIG. 6, point I represents an actual pose of point i, point J represents an actual pose of point j, and point M represents an actual pose of point m. To reduce the cumulative error, when the autonomous mobile device passes through a previously explored region, a loop closure module may calculate a constraint relationship between the current pose and some historical poses. For example, the bolded double arrow in FIG. 6 represents a loop closure constraint, and the current pose is corrected based on the loop closure constraint. A certain pose in the pose graph has a high similarity with an image frame corresponding to the current pose, and the loop closure constraint may be calculated based on the pose having the high similarity with the image frame. For example, as illustrated in FIG. 6, the image frame corresponding to point 3 has a high similarity with the image frame corresponding to point i, so that the loop closure constraint between point 3 and point i may be calculated.

In the embodiments of the disclosure, a sliding window method is used to construct the pose graph. Specifically, the pose graph in the embodiments of the disclosure includes at least one window, and a size of each window may be determined based on the maximum number of nodes supported by the window. The maximum number of nodes supported by each window may be preset based on an environmental change in the actual operation scenario. When the environmental change of a region is significant, the maximum number of nodes supported by the window corresponding to the region is large. When the environmental change of a region is minor, the maximum number of nodes supported by the window corresponding to the region is small.

In some embodiments, the size of the window may be dynamically adjusted based on segmented regions. For example, the size of the window (i.e., the maximum number of nodes supported by the window) corresponding to each region may be preset, based on environmental changes of the various regions in the actual operation scenario of the autonomous mobile device. During the autonomous mobile device moves and performs mapping in real-time, a window size of a current window corresponding to a current located region where the autonomous mobile device is located may be obtained. Based on the obtained window size, the size of the current window is adjusted to be the same as the window size corresponding to the current located region. In the embodiments, by dynamically adjusting the window size in real-time based on the environmental change, the precision and accuracy of local mapping can be improved, thereby improving the accuracy of global map updating.

In some other embodiments, during the autonomous mobile devices moves and performs mapping in real-time, a current region where the autonomous mobile device is located may be acquired, an actual environmental change rate of a dynamic region in the global map may be calculated, and a window size corresponding to the current region may be dynamically adjusted in real-time based on the actual environmental change rate. In the embodiments, by dynamically adjusting the window size in real-time based on the environmental changes, the precision and accuracy of local mapping can be improved, thereby improving the accuracy of global map updating.

For each window in the pose graph, when the number of nodes included in the current window reaches a first preset number, the nodes in the current window are optimized to obtain optimized nodes, and a locally optimized pose graph is thereby obtained. Specifically, the first preset numbers for the individual windows may be different, and the first preset number for each window may be the maximum number of nodes supported by the window. For example, when constructing the current window, a constraint relationship between the nodes in the current window are constructed to form a pose graph in the current window (the pose graph in the current window may also be referred to as a batch). An actual constraint relationship between the nodes in the pose graph in the current window is an “actual observation constraint” in the laser scanning data corresponding to these nodes, a “calculated observation constraint” may be calculated based on the poses of the nodes in the current window, and a residual error between the “actual observation constraint” and the “calculated observation constraint” is calculated for each node in the current window. By summing the residual errors corresponding to all nodes in the current window, the least squares method may be used to determine the poses of all nodes in the current window that minimize the sum of residual errors. In other words, the poses of all nodes in the current window which make the sum of residual errors minimized are taken as the optimized poses.

To alleviate map fragmentation caused by excessive errors of the odometer data, in the embodiments of the disclosure, for each newly added node in the pose graph, a scan matching method is adopted to correct the pose of the node in the pose graph. Specifically, after optimizing the nodes in the current window, laser scanning data corresponding to the optimized nodes may be acquired from the sensor data, and a matching map corresponding to the current window is generated based on the laser scanning data corresponding to the optimized nodes. For example, based on the poses of the optimized nodes and each frame of the laser scanning data contained in the nodes, laser scanning data contained in all the nodes of the current window may be converted to a global map coordinate. Ray tracing is performed for each laser beam, and an occupancy probability of each grid cell in the global map is calculated based on a probability that the laser beam hits the grid cell, thereby obtaining the matching map, where each grid cell in the matching map stores its occupancy probability. Generally, the occupancy probability that the grid cell is hit by the laser beam is high, and the occupancy probability that the laser beam misses the grid cell is low. In practical scenarios, when a laser beam hits an obstacle, the grid cell corresponding to the obstacle in the global map has a high occupancy probability.

After optimizing the nodes in the current window, a next window is constructed. The first node in the next window is the last node in the current window. The matching map corresponding to the current window is used to perform corrections on the nodes in the next window.

Specifically, for each newly added node in the next window, the pose of the newly added node is corrected based on the matching map corresponding to the current window. For example, for each newly added node in the next window, it is taken as a current node, and multiple candidate nodes of the current node are acquired, based on a pose sampling interval, in a specified region centered on the current node. Specifically, the pose sampling interval includes a position sampling interval and an angle sampling interval, and the pose sampling interval and the specified region may be preset based on actual requirements, which are not specifically limited herein. For each of the multiple candidate nodes, a matching value of each candidate node is calculated as follows. Laser scanning data corresponding to a current candidate node is acquired from the sensor data. A grid cell in the matching map that is hit by the laser scanning data corresponding to the current node is determined as a target grid cell. A probability that the target grid cell is hit by the laser scanning data corresponding to the current candidate node is calculated as a first occupancy probability. The occupancy probability of the target grid cell that is stored in the matching map is acquired as a second occupancy probability. A difference between the first occupancy probability and the second occupancy probability is calculated as the matching value of the current candidate node with the matching map. After the matching values of all the multiple candidate nodes are calculated, a candidate node with the highest matching value among the multiple candidate nodes is selected to correct the current node.

At S122, in response to meeting the preset condition for periodically releasing a local map, a globally optimized pose graph is obtained by performing global optimization on the pose graph.

The condition for periodically releasing a local map may be set in advance based on an environment in the actual operation scenario of the autonomous mobile device, a moving speed of the autonomous mobile device, and a relative motion constraint relationship between the nodes in the pose graph (for example, a distance between two adjacent nodes needs to be greater than or equal to 50 centimeters).

For example, the preset condition for periodically releasing a local map may include at least one of: the number of nodes in the pose graph reaches a second preset number, a moving distance of the autonomous mobile device reaches a preset distance, and a duration from the start of constructing the pose graph to the current moment reaches a preset duration. Specifically, the second preset number is greater than the first preset number, and may be set based on the window size. For example, the second preset number may be the maximum number of nodes supported by three windows. The preset distance and the preset duration may be set based on actual requirements. For example, the preset duration may be 5 minutes.

Global optimization on the pose graph refers to optimizing all nodes in the current pose graph, and the method for performing global optimization on the pose graph is similar to the above-described method for optimizing nodes in a window, with the only difference being the number of nodes involved in the optimization. For example, the “actual observation constraint” corresponding to each node in the current pose graph may be acquired, the “calculated observation constraint” corresponding to each node in the current pose graph may be calculated, and a residual error between the “actual observation constraint” and the “calculated observation constraint” may be calculated for each node in the current pose graph. By summing the residual errors corresponding to all nodes in the current pose graph, the least squares method may be used to determine the poses of all nodes in the current pose graph that minimize the sum of residual errors. In other words, the poses of all nodes in the current pose graph which make the sum of residual errors minimized are taken as the optimized poses. The global optimization on the pose graph is performed before releasing the local map, which can improve the consistency of the map.

At S123, the local map is constructed based on the globally optimized pose graph.

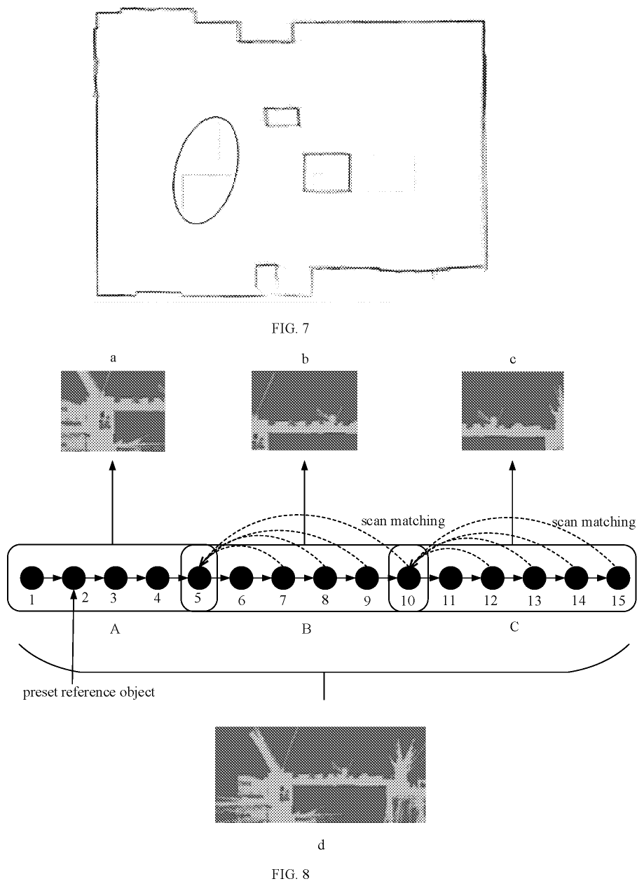

The local map with the same size as the globally optimized pose graph may be constructed based on the globally optimized pose graph. For example, based on the poses of the nodes in the globally optimized pose graph and each frame of laser scanning data contained in the nodes, laser scanning data contained in all the nodes of the globally optimized pose graph may be converted to the global map coordinate system. Ray tracing is performed for each laser beam, and an occupancy probability corresponding to each grid cell is calculated based on a probability that the laser beam hits the grid cell in the local map, thereby obtaining the local map, where each grid cell in the local map stores the occupancy probability of the grid cell. In the embodiments of the disclosure, the local map is constructed based on the poses of the nodes in the globally optimized pose graph and each frame of laser scanning data contained in the nodes. In this way, it alleviates ghosting (such as the part circled in FIG. 7) in the local map caused by moving objects (such as walking people and other moving autonomous mobile devices) in the actual operation scenario and artifacts caused by insufficient observation.

After releasing the local map, a specified number of nodes may be sequentially removed from the pose graph based on a chronological order of the additions of these nodes, so as to control the size of the pose graph and the size of a local map to be constructed in the next cycle, thereby reducing cumulative error by limiting the coverage range of the local map. The specified number may be set based on actual requirements. For example, the specified number may be half of the total number of nodes included in the globally optimized pose graph. After removing the specified number of nodes, S121 to S123 of the method may be repeated for a next cycle of local map construction until the autonomous mobile device stops moving.

For convenience of understanding, an example is provided herein to describe S121 to S123 of the local map construction. As illustrated in FIGS. 8 to 11, points 1 to 15 are nodes in the pose graph. The maximum number of nodes that can be included in the first window A is 5, and points 1 to 5 are nodes in the first window A. The maximum number of nodes that can be included in the second window B is 6, and points 5 to 10 are nodes in the second window B. The maximum number of nodes that can be included in the third window C is 6, and points 10 to 15 are nodes in the third window C. Each time one pose and one frame of sensor data are acquired, a node in the pose graph is determined based on the pose and the frame of sensor data.

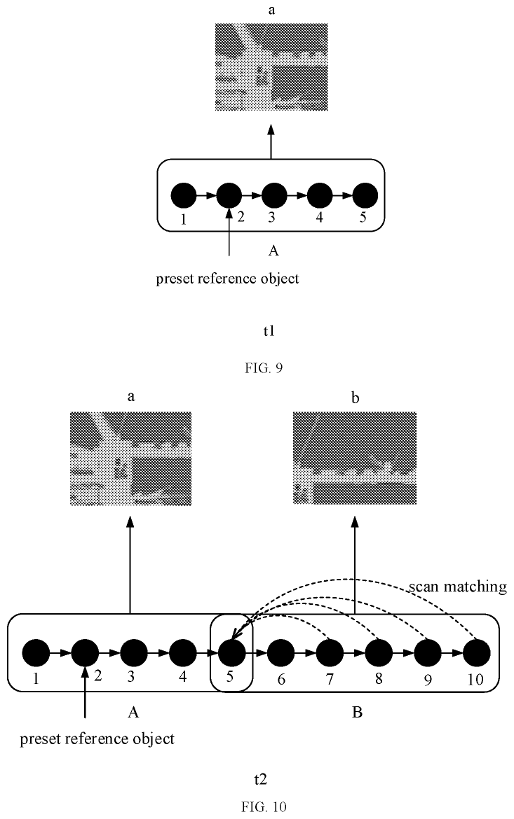

Windows A to C are constructed sequentially (one by one). As illustrated in FIG. 9, when the number of nodes included in the first window A reaches, at time t1, the maximum number of 5 nodes that the window is capable of including, all nodes 1 to 5 in the first window A are optimized, and a matching map a corresponding to the first window A is constructed based on the optimized nodes.

As illustrated in FIG. 10, a second window B is constructed at time t2 (t2>t1), with the first node of the second window B being point 5. The scan matching method is adopted to correct, based on the matching map corresponding to the first window A, the poses of nodes added to the second window B. When the number of nodes in the second window B reaches the maximum number of 6 nodes that the window is capable of including, all nodes 5 to 10 in the second window B are optimized, and a matching map b corresponding to the second window B is constructed based on the optimized nodes.

As illustrated in FIG. 11, a third window C is constructed at time t3 (t3>t2), with the first node of the third window C being point 10. The scan matching method is adopted to correct, based on the matching map b corresponding to the second window B, the poses of nodes added to the third window C. When the number of nodes included in the third window C reaches the maximum number of 6 nodes that the window is capable of including, all nodes 10 to 15 in the third window C are optimized, and a matching map c corresponding to the third window C is constructed based on the optimized nodes. At that time, the number of nodes included in the three windows A to C reaches the number of 15 nodes for periodically releasing a local map. Global optimization is performed on nodes 1 to 15 in the three windows A to C to obtain a globally optimized pose graph, and a local map (a local map d illustrated in FIG. 8) is constructed based on the globally optimized pose graph.

In some embodiments, the above-mentioned preset reference object information may be further released when releasing the local map to assist subsequent map alignment.

At S130, a target local map aligned with the global map is obtained by aligning the global map with the local map.

Map alignment is performed based on the image feature point matching technology and point cloud matching technology, with a main purpose of calculating a spatial relationship between the local map and the global map for updating the global map. Since the local map inevitably has a cumulative error, map alignment requires matching each local map with the global map to reduce the cumulative error, ensuring the consistency of the global map. In addition, the aligned local map is used to update the global map in real-time with high accuracy.

After obtaining the local map, a global sub-map is determined in the global map based on a center and a size of the local map, with a center of the global sub-map coinciding with the center of the local map, and a size of the global sub-map being the same as the size of the local map.

The Oriented Fast and Rotated Brief (ORB) algorithm is adopted to extract ORB features of the local map as first features, and extract ORB features of the global sub-map as second features. The ORB algorithm may be used to quickly create feature vectors for key points in both the local map and the global map, and these feature vectors may be used to identify objects in the local map and the global map. In the ORB algorithm, “fast” refers to a feature detection algorithm, and “brief” refers to a vector creation algorithm. The feature detection algorithm in the ORB algorithm is used to identify keypoints from the local map and the global map. The keypoints are distinct small regions in an image, such as corners or points characterized by a sharp transition in pixel values from light to dark. The vector creation algorithm in the ORB algorithm is used to calculate a feature vector corresponding to each keypoint to obtain the ORB features. The feature vector generated by the ORB algorithm includes only 1 and 0, which is also referred to as a binary feature vector. The order of 1 and 0 varies based on a specific keypoint and its surrounding pixel region. The feature vector represents an intensity pattern around the keypoint, and the multiple feature vectors may be used to identify a larger region, even a specific object in the local map and the global map. The ORB algorithm has a fast calculation speed and is relatively robust against noise and image transformations such as rotation and scaling.

After obtaining the first features of the local map and the second features of the global sub-map, the global map and the local map are aligned based on the first features and the second features to obtain a local map aligned with the global map.

Specifically, image coordinates of the first features in the local map are acquired, and a first point cloud corresponding to the first features is obtained. Image coordinates of the second features in the global sub-map are acquired, and a second point cloud corresponding to the second features is obtained. An initial value for map alignment is determined based on the first features, the first point cloud, the second features, and the second point cloud. For example, an ORB feature matching algorithm in OpenCV is used to perform feature matching between the first features and the second features to obtain initial correspondences between the first features and the second features. An outlier in the initial correspondences is removed by using a discrete point removal algorithm, and a transformation relationship between the first point cloud and the second point cloud is calculated, thereby obtaining correct correspondences between the first features and the second features, and a transformation relationship between the first point cloud and the second point cloud. The discrete point removal algorithm may include, but is not limited to, the Graph Reliability Outlier Removal (GROR) algorithm, the Median Absolute Deviation (MAD) algorithm, a standard deviation algorithm, a percentile algorithm, and the like. When the number of the correct correspondences is greater than a preset quantity, the transformation relationship between the first point cloud and the second point cloud is determined as the initial value for map alignment. When the number of the correct correspondences are less than or equal to the preset quantity, the local map is determined as the initial value for map alignment. The preset quantity is set based on scene features of the actual operation scenario (such as the complexity and change degree of the scene). For example, the preset quantity may be 50.

Based on the initial value for map alignment, the global map and the local map are aligned by using a cloud alignment algorithm, thereby obtaining the local map aligned with the global map. The point cloud alignment algorithm may be, but is not limited to, the Iterative Closest Point (ICP) algorithm. For example, alignment is performed on the initial value for map alignment by using the point cloud alignment algorithm, and an alignment result and a residual error are thereby obtained. Specifically, the alignment result is a transformation relationship between a local map coordinate system and a global map coordinate system, that is, a transformation relationship for aligning the local map with the global map. When the residual error is less than a preset residual error (which is determined based on the actual operation scenario), the alignment is deemed successful. Then, coordinate transformation is performed on the local map based on the alignment result, thereby obtaining the target local map aligned with the global map. When the residual error is greater than or equal to the preset residual error, it is determined that the alignment fails. In this case, the local map is discarded to prevent errors in subsequent global map updating caused by a mismatch between the local map and the global map.

In some embodiments, in a case where the preset reference object information is received, the preset reference object information may be incorporated when the alignment is performed on the initial value for map alignment by using the point cloud alignment algorithm, thereby assisting in map alignment and improving the alignment accuracy.

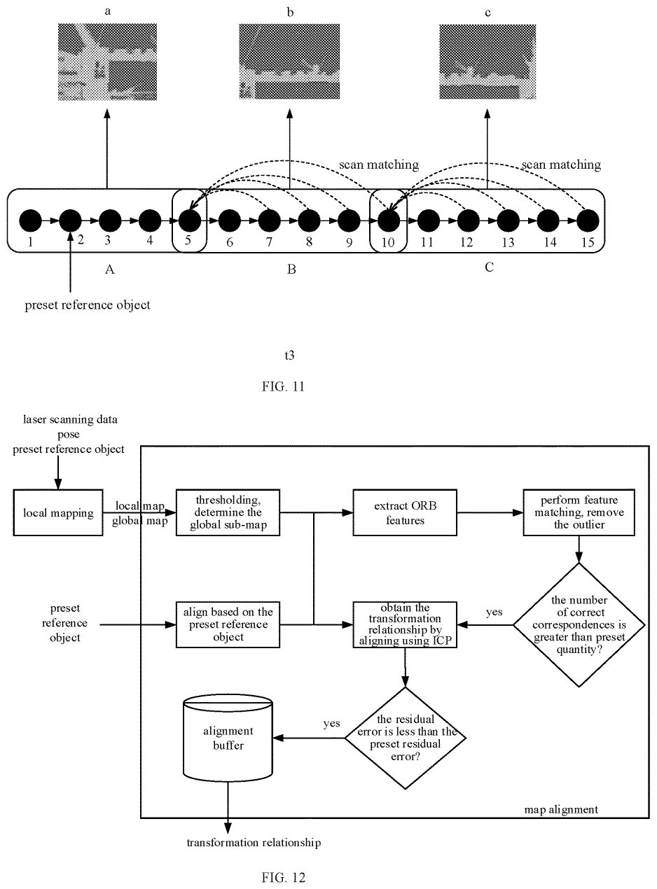

For example, referring to FIG. 12, S130 may include the process illustrated in FIG. 12. The local map is constructed by local mapping based on the laser scanning data, the pose output by the LiDAR odometer, and the preset reference object information. Thresholding is applied to both the global map and the local map. The global sub-map is identified from the global map based on the local map. The ORB features of the local map and the ORB features of the global sub-map are extracted, and then matching is performed therebetween to obtain the initial correspondences. The GROR algorithm is adopted to remove the outlier from the initial correspondences, thereby obtaining the correct correspondences. Then, it is determined whether the number of the correct correspondences exceeds the preset quantity. When the number of the correct correspondences is greater than the preset quantity, the point cloud of the ORB features of the local map and the point cloud of the ORB features of the global sub-map are taken as the initial value for map registration. When the number of the correct correspondences is less than or equal to the preset quantity, the local map is taken as the initial value for map registration. The ICP algorithm is applied to perform alignment on the initial value for map registration, thereby obtaining the residual error and the transformation relationship for the alignment between the local map and the global map. It is determined whether the residual error is less than the preset residual error. When the residual error is less than the preset residual error, the registration is deemed successful, and the transformation relationship for the alignment between the local map and the global map is stored in an alignment buffer and sent to the map updating module, so that the map updating module is enabled to update the global map based on the local map aligned with the global map.

At S140, the global map is updated, based on the global map, the semantic map, and the target local map.

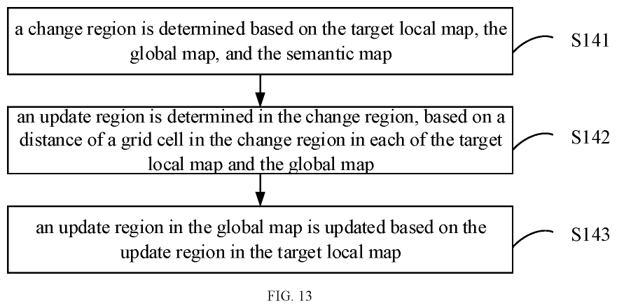

In some embodiments, referring to FIG. 13, S140 may include S141 to S143.

At S141, a change region is determined, based on the target local map, the global map, and the semantic map.

An intersection of the target local map and the global map is calculated as an overlapping region between the target local map and the global map. Generally, there is an overlapping region between the target local map and the global map, unless the autonomous mobile device moves beyond the bounds of the global map, that is, the autonomous mobile device moves off the coverage of the global map. For example, in a case where the autonomous mobile device passes by a closed door when constructing the global map, an area inside the door would not be included in the global map; and when the autonomous mobile device passes the same door again, the door is open, and the autonomous mobile device enters the area inside the door, there is no overlapping region between the area inside the door and the global map.

After the overlapping region is determined, the change region may be determined based on the semantic map, and the grid cells in the overlapping region. For example, it may detect whether a grid cell in the overlapping region is located in the static region or the dynamic region as labeled in the semantic map. When it is detected that the grid cell in the overlapping region is located in the dynamic region as labeled in the semantic map, it indicates that the region corresponding to the grid cell would be changed. The grid cell in the overlapping region that is located within the dynamic region as labeled in the semantic map is determined as the change region. When it is detected that the grid cell in the overlapping region is located in the static region as labeled in the semantic map, it indicates that the region corresponding to the grid cell would not be changed, and the state of the corresponding grid cell in the global map may remain unchanged, and the process continues to traverse other grid cells in the overlapping region. Filtering using the semantic map can effectively alleviate the degradation of map quality caused by long-term updates. This can avoid redundant updates of the static object, thereby avoiding double image in the global map.

At S142, an update region is determined in the change region, based on a distance of a grid cell in the change region in each of the target local map and the global map.

For each grid cell in the change region, a distance between the grid cell and the nearest obstacle in the target local map is acquired as a first distance of the grid cell in the change region. For example, a distance map corresponding to the target local map may be acquired, and in this distance map, each grid cell stores the distance from the grid cell to the nearest obstacle. The distance from the grid in the change region to the nearest obstacle in the target local map is acquired based on the distance map.

For each grid cell in the change region, a distance between the grid cell and the nearest obstacle in the global map is acquired as a second distance of the grid cell in the change region. For example, a distance map corresponding to the global map may be acquired, and in this distance map, each grid cell stores the distance from the grid cell to the nearest obstacle. The distance from the grid in the change region to the nearest obstacle in the global map is acquired based on the distance map.

The update region in the change region is determined, based on the first distance and the second distance of the grid cell in the change region. Specifically, for each grid cell in the change region, it is taken as a current grid cell, and a likelihood algorithm is adopted to calculate a likelihood value of change for the current grid cell, based on the first distance and the second distance of the current grid cell. A region in the change region corresponding to a grid cell whose likelihood value exceeds a specified likelihood value is determined as the update region. For example, the likelihood value (ranging from 0 to 1) of change for each grid cell may be calculated using the following formula:

$${e}^{- \frac{{d}_{mea} - {d}_{exp}}{2 {σ}^{2}}}$$

where dₘₑₐ represents the first distance, dₑₓₚ represents the second distance, σ represents a control parameter of the likelihood function, and the stringency of update region segmentation may be adjusted by adjusting the parameter σ.

After the update region is determined, the moving object may be filtered out from the target local map by adjusting a distance map parameter. For example, the distance map parameter may be a threshold used to compare with the likelihood value calculated using the above formula, so as to filter out, from the target local map, the moving object corresponding to the grid cell whose likelihood value is greater than or equal to the distance map threshold.

By using the likelihood algorithm to identify update regions, it ensures the completeness of the update region, so that the global map can be updated timely, thereby preventing redundant updates to the static region.

At S143, the update region in the global map is updated based on the update region in the target local map.

A preset unknown probability and the occupancy probability of each grid cell in the update region that is stored in the target local map are acquired. For each grid cell in the update region, it is taken as a current grid cell, and a difference between the occupancy probability of the current grid cell and the preset unknown probability is calculated. For example, based on the difference between the occupancy probability of the current grid cell and the preset unknown probability, the global map may be updated using the following formula:

$${m}_{a} ( i , j ) = \{ \begin{matrix}{m}_{s} ( i , j ) , & \vert {m}_{a} ( i , j ) - α \vert < ε \\ {m}_{l} ( i , j ) , & others\end{matrix}$$

where mₐ(i,j) represents the updated map, mₛ(i,j) represents the global map, mₗ(i,j) represents the local map, (i,j) represents locations of the grid cell, α represents the preset unknown probability (e.g., 0.5 or −1), and ε represents a specified tolerance value that may be set based on actual requirements for a precision of map updates.

When an absolute value of the difference corresponding to the current grid cell is less than the specified tolerance value, it indicates that the state of the grid cell is uncertain, and the occupancy state of the current grid cell is determined as an unknown state. When the absolute value of the difference corresponding to the current grid cell is greater than or equal to the specified tolerance value, the state of the current grid cell is known, and the occupancy state of the current grid is determined as a known state.

For each grid cell in the update region, the occupancy state of the grid cell in the target local map is acquired, where the occupancy state includes the known state and the unknown state. In the target local map, the grid cell in the update region whose occupancy state is the known state is determined as a to-be-updated grid cell, and the grid cell in the update region whose occupancy state is the unknown state is determined as an unchanged grid cell. The grid cell corresponding to the to-be-updated grid cell in the global map is updated based on the grid cell corresponding to the to-be-updated grid cell in the target local map. The grid cell corresponding to the unchanged grid cell in the global map remains unchanged.

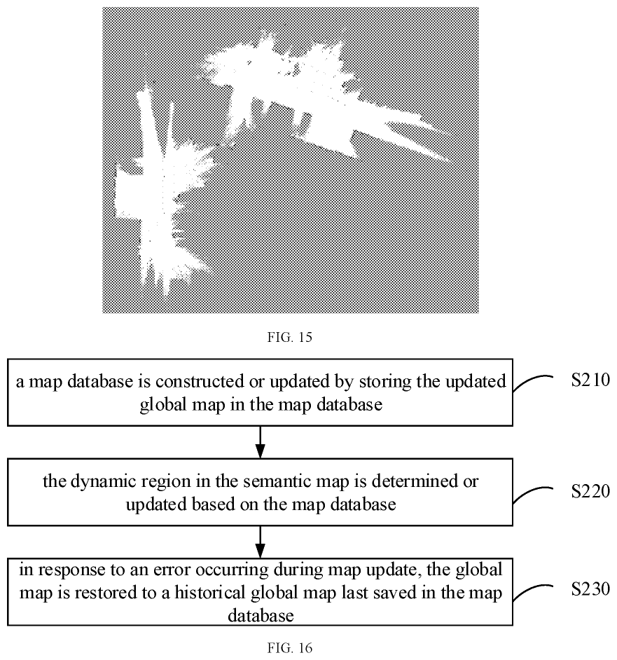

Through S141 to S143, the change region is determined based on three maps including the target local map, the global map, and the semantic map in which the static region and the dynamic region of the global map are labeled. The update region is identified in the change region, based on the stored distances for the grid cells in the target local map and global map. The update region in the global map is updated using the update region in the target local map. The update region is determined by using the semantic map in which the static region and the dynamic region are labeled, and based on the multiple dynamic region identifications, thereby enabling the dynamic object of low change cycle to be detected, and effectively filtering out the moving object of the global map. In this way, completeness of the key features of the global map can be ensured, and redundant updates to the static object can be avoided. Thus, it can reduce ghosting (as circled in FIG. 7) and double image in the global map, which enhances the authenticity and the consistency of the global map, thereby effectively alleviating the degradation in map quality caused by long-term updates. The global map is partially updated using the update region in the local map, which is updated on a small update range and has low memory consumption. Furthermore, by fully considering the spatial relationship between the local map and the global map, even if a local update fails, it would not cause a significant deviation in a partial region of the global map (as illustrated in FIG. 15, two white regions represent regions before and after the deviation, respectively). Thus, the consistency, reliability, and accuracy of the updated global map can be ensured.

In the map updating method according to the embodiments of the disclosure, the local map may be periodically constructed based on the pose of the autonomous mobile device and the sensor data, where the periodically constructed local map has a limited coverage range. The local map is aligned to obtain the target local map aligned with the global map. The global map is updated, based on the global map, the semantic map, and the target local map, which enables the global map to be updated each time on a small scale, rather than updating the entire global map. This ensures the consistency of the global map, enhances the quality of the global map, thereby improving the efficiency and accuracy of the map update. Furthermore, the update region is determined by using the semantic map in which the static region and the dynamic region are labeled, and based on the multiple dynamic region identifications, so that the dynamic objects of low change cycle can be detected, and the moving object in the global map can be effectively filtered out. In this way, completeness of the key features of the global map can be ensured, and redundant updates to static object can be avoided. Thus, it can reduce the ghosting and double image in the global map, which enhances the authenticity and the consistency of the global map, thereby effectively alleviating the degradation in map quality caused by long-term updates. The global map is partially updated using the update region in the local map, which is updated on a small update range and requires low memory consumption. Furthermore, by fully considering the spatial relationship between the local map and the global map, even if a local update fail, it would not cause a significant deviation in a partial region of the global map. Thus, the consistency, reliability, and accuracy of the updated global map can be ensured.

In some embodiments, referring to FIG. 16, after S140, the map updating method may further include S210 to S230 for managing the updated global map.

At S210, a map database is constructed or updated by storing the updated global map in the map database.

At S220, the dynamic region in the semantic map is determined or updated based on the map database.

Based on S220, the semantic map may be maintained in real-time using the updated map to assist the aforementioned map alignment and map update processes. For the detailed description of S220, reference may be made to the relevant contents of the map database analysis method described above.

At S230, in response to an error occurring during map update, the global map is restored to a historical global map last saved in the map database.

Specifically, the error occurring during map update refers to an obvious error rather than a minor error. For example, the obvious error may include, but is not limited to, the aforementioned low map matching accuracy and significant degradation in the localization confidence of the autonomous mobile device.

Based on S210 to S230, in a case where the obvious error occurs in mapping or localization, a normal process may be restored through map rollback, thereby enhancing the robustness of map updates.

In some embodiments, after S140, the map updating method may further include a map sharing step, that is, sharing the updated map with another autonomous mobile device and acquiring an updated map sent by another autonomous device. In this way, the risk of localization failure for any single autonomous mobile device is reduced, thereby improving the reliability of map updates.

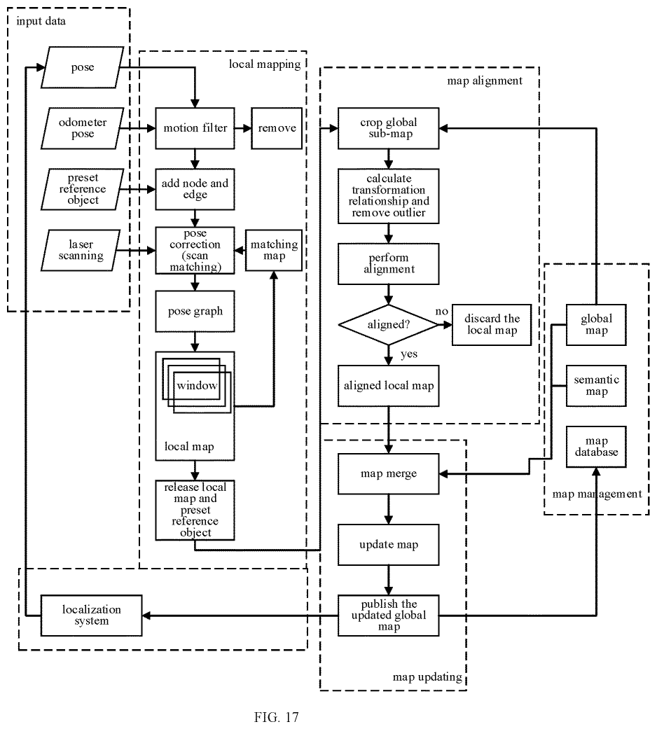

For example, referring to FIG. 17, FIG. 17 is a flowchart of a map updating method according to an exemplary embodiment of the disclosure. The map updating method includes four parts: local mapping, map alignment, map update, and map management.

Specifically, the input data for local mapping may include the pose output by the LiDAR odometer, the pose output by the localization system, the preset reference object information, and the laser scanning data. The local mapping may include operations as follows. Motion filtering is performed on the poses output by the LiDAR odometer and the localization system, so as to filter out poses that do not meet a requirement. The node and the edge of the pose graph are added based on the pose that meets the requirement and the preset reference object information. The node is corrected using the scan matching method based on the laser scanning data. The matching map is generated based on the pose graph in each window, when the size of the pose graph reaches a certain threshold. The node correction is performed based on the matching map. The preset reference object information and the matching map constructed based on the pose graph are output to the map aligning module, when the condition for periodically releasing a local map is met.

The map alignment may include operations as follows. The global sub-map is obtained by cropping the global map based on the local map. The transformation relationship between the local map and the global sub-map is calculated. The outlier is removed from the transformation relationship, and the alignment is performed on the transformation relationship after removement of the outlier. It is determined whether the local map and the global map are successfully aligned. When the alignment is successful, the target local map aligned with the global map is output to the map updating module. When the alignment fails, the local map is discarded.

The map update may include operations as follows. The maps are merged, i.e., the update region is determined based on the target local map and the global map. The update region in the global map is updated with the update region in the target local map. The updated map is released to the localization system and map management module.

The map management includes operations as follows. A map database is constructed to store the global map and the semantic map. Upon receiving a retrieval request for global map and semantic map from the map updating module, the semantic map and the global map are sent to the map updating module. In addition, a roll back is performed on the map data to restore the normal workflow, when the significant error occurs in map updates.

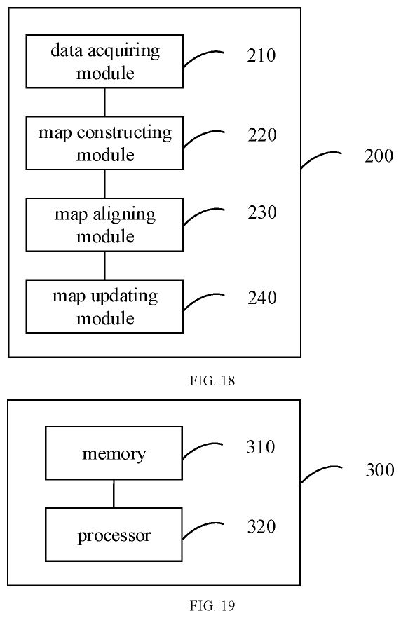

FIG. 18 is a structural block diagram of a map updating apparatus according to an embodiment of the disclosure. The map updating apparatus 200 may be applied to the autonomous mobile device. The map updating apparatus 200 includes a data acquiring module 210, a map constructing module 220, a map aligning module 230, and a map updating module 240.

The data acquiring module 210 is configured to acquire a pre-constructed global map, a semantic map, and a pose and sensor data of the autonomous mobile device, where in the semantic map, a static region and a dynamic region of the global map are labeled. For the specific working process of the data acquiring module 210, reference may be made to S110 described above, which will not be repeated here.

The map constructing module 220 is configured to periodically construct a local map based on the pose and the sensor data, the periodically construct local map has a limited coverage range. For the specific working process of the map constructing module 220, reference may be made to S120 described above, which will not be repeated here.

The map aligning module 230 is configured to obtain a target local map aligned with the global map, by aligning the global map with the local map. For the specific working process of the map aligning module 230, reference may be made to S130 described above, which will not be repeated here.

The map updating module 240 is configured to update the global map based on the global map, the semantic map, and the target local map. For details of the working process of the map updating module 240, reference may be made to S140 described above, which will not be repeated here.

In some embodiments, the map updating apparatus 200 further includes a map management module. After the global map is updated, the map management module is configured to: construct or update a map database by storing the updated global map in the map database; determine or update the dynamic region in the semantic map based on the map database; and in response to an error occurring during map update, restore the global map to a historical global map last saved in the map database. For details of the working process of the map management module, reference may be made to S210 to S230 described above, which will not be repeated here.

It is clear for those skilled in the art that the map updating apparatus according to the embodiments of the disclosure may implement the map updating method according to the embodiments of the disclosure. For details of the working processes of the apparatus and the modules, reference may be made to the corresponding processes in the method embodiments of the disclosure, which will not be repeated here.

In the embodiments of the disclosure, the coupling, including direct coupling or communication connection, between the modules shown or discussed may be indirect coupling or communication connection by means of some interfaces, devices or modules, and may be electrical, mechanical or in other forms, which is not specifically limited in the embodiments of the disclosure.

In addition, the various functional modules in the embodiments of the disclosure may be integrated into one processing module, or each of the various modules may exist alone physically, or two or more modules may be integrated into one module. The integrated module may be implemented in hardware or in software functional modules.

FIG. 19 is a structural block diagram of an autonomous mobile device according to another embodiment of the disclosure. The autonomous mobile device 300 may include a memory 310 and a processor 320. The memory 310 stores an application program which, when being invoked by the processor 320, causes the method according to the embodiments of the disclosure to be implemented.

The processor 320 may include one or more processing cores. The processor 320 may be connected to various parts of the entire autonomous mobile device 100 by using various interfaces and lines, and execute various functions of the autonomous mobile device 100 and process data by running or executing instructions, programs, code sets, or instruction sets stored in the memory 310, and calling data stored in the memory 310. The processor 320 may be implemented in at least one hardware of a digital signal processing (DSP), a field-programmable gate array (FPGA), and a programmable logic array (PLA). The processor 320 may integrate one or more of a central processing unit (CPU), a graphics processing unit (GPU), and a modem. Specifically, the CPU mainly handles an operating system, a user interface, an application, or the like; the GPU is configured to render and draw the content; and the modem is configured to handle a wireless communication. It can be understood that the modem may not be integrated into the processor 320, and may be implemented as a single chip.

The memory 310 may include a random access memory (RAM), and may include a read-only memory (ROM). The memory 310 may be configured to store instructions, programs, codes, code sets, or instruction sets. The memory 310 may include a program storage area and a data storage area. Specifically, the program storage area may be configured to store instructions for implementing the operating system, instructions for realizing at least one function, instructions for implementing the following method embodiments, etc. The data storage area may store data created by the autonomous mobile device 300 during operation.

The embodiments of the disclosure further provide a computer-readable storage medium. The computer-readable storage medium having program codes stored thereon. When the program codes are invoked by a processor, the method according to the embodiments of the disclosure is executed. The computer-readable storage medium may be an electronic memory such as a flash memory, electrically-erasable programmable read-only memory (EEPROM), erasable programmable read-only memory (EPROM), hard disk, or read-only memory (ROM). In some embodiments, the computer-readable storage medium includes a non-transitory computer-readable storage medium (Non-TCRSM). The computer-readable storage medium has a storage space for program codes that perform any operation in the above methods. The program codes may be read from or written to one or more computer program products. The program codes may be compressed in any appropriate forms.

According to the map updating method and apparatus, the autonomous mobile device, and the storage medium provided by the embodiments of the disclosure, the local map may be periodically constructed based on the pose and the sensor data of the autonomous mobile device, where the periodically constructed local map has a limited coverage range. The local map is aligned to obtain the target local map aligned with the global map. The global map is updated, based on the global map, the semantic map, and the target local map. This enables the global map to be updated each time on a small scale, and avoids a full update to the global map. This ensures the consistency of the global map, improves the quality of the global map, and enhances the efficiency and accuracy of map updating.

Finally, it is notable that the above embodiments are merely intended to illustrate the technical solutions of the disclosure, rather than limiting it. Although the disclosure has been described in detail with reference to the foregoing embodiments, it can be understood that those of ordinary skill in the art can modify the technical solutions described in the foregoing embodiments or make equivalent substitutions for some technical features therein. These modifications or substitutions do not drive the essence of the corresponding technical solutions away from the spirit and scope of the technical solutions of the embodiments of the disclosure.

What is claimed is:

1. A map updating method, comprising:
acquiring a pre-constructed global map, a semantic map, and a pose and sensor data of an autonomous mobile device, wherein in the semantic map, a static region and a dynamic region of the global map are labeled;
periodically constructing a local map based on the pose and the sensor data, wherein the periodically constructed local map has a limited coverage range;
obtaining, by aligning the global map with the local map, a target local map aligned with the global map; and
updating the global map, based on the global map, the semantic map, and the target local map.

2. The map updating method according to claim 1, wherein periodically constructing the local map based on the pose and the sensor data, comprises:
each time one pose and one frame of sensor data of the autonomous mobile device are acquired, constructing a pose graph in real-time based on the acquired pose and sensor data;
in response to meeting a preset condition for periodically releasing a local map, obtaining a globally optimized pose graph by performing global optimization on the pose graph; and
constructing the local map based on the globally optimized pose graph.

3. The map updating method according to claim 2, wherein constructing the pose graph in real-time based on the acquired pose and sensor data, comprises:
constructing the pose graph in real-time based on the pose and the sensor data, wherein the pose graph comprises at least one window; and
for each window in the pose graph, taking this window as a current window, in response to an amount of nodes comprised in the current window reaching a first preset number, obtaining, by optimizing nodes in the current window, optimized nodes, and thereby obtaining a locally optimized pose graph.

4. The map updating method according to claim 3, wherein the sensor data comprises laser scanning data; after obtaining the optimized nodes and the locally optimized pose graph, the method further comprises:
acquiring, from the sensor data, laser scanning data corresponding to the optimized nodes;
generating, based on the laser scanning data corresponding to the optimized nodes, a matching map corresponding to the current window; and
correcting nodes in a next window based on the matching map corresponding to the current window.

5. The map updating method according to claim 4, wherein correcting the nodes in the next window based on the matching map corresponding to the current window, comprises:
for each node in the next window, taking this node as a current node, and acquiring, based on a pose sampling interval, a plurality of candidate nodes for the current node;
for each of the plurality of candidate nodes, taking this candidate node as a current candidate node, and calculating a matching value of the current candidate node, comprising:
acquiring, from the sensor data, laser scanning data corresponding to the current candidate node;
determining, as a target grid cell, a grid cell in the matching map that is hit by the laser scanning data corresponding to the current node;
calculating, as a first occupancy probability, a probability that the target grid cell is hit by the laser scanning data corresponding to the current candidate node;
acquiring, as a second occupancy probability, an occupancy probability of the target grid cell that is stored in the matching map, wherein the occupancy probability of each grid cell that is stored in the matching map is calculated based on the laser scanning data corresponding to the optimized nodes; and
calculating, as a matching value of the current candidate node with the matching map, a difference between the first occupancy probability and the second occupancy probability; and
selecting, from the plurality of candidate nodes, a candidate node with the highest matching value, and correcting the current node with the selected candidate node.

6. The map updating method according to claim 3, wherein constructing the pose graph in real-time based on the acquired pose and sensor data, comprises:
for each pose and each frame of sensor data, taking this pose as a current pose and taking this frame of sensor data as current sensor data, in response to the current pose meeting a preset condition, adding the current pose as a node to the pose graph; in response to the current sensor data comprising preset reference object information, adding a pose of a preset reference object as a node to the pose graph; and
acquiring a constraint relationship of the nodes in the pose graph, and constructing an edge of the pose graph based on the constraint relationship;
wherein the method further comprises:
acquiring a pose at a previous moment;
calculating a distance difference and an angle difference between the current pose and the pose at the previous moment; and
in response to the distance difference being greater than a preset distance and/or the angle difference being greater than a preset angle difference, determining that the current pose meets the preset condition.

7. The map updating method according to claim 2, wherein after constructing the local map based on the globally optimized pose graph, the method further comprises:
sequentially removing a specified number of nodes from the pose graph based on a chronological order of adding the nodes to the pose graph, thereby controlling a size of the pose graph and a size of a local map to be constructed in a next cycle.

8. The map updating method according to claim 2, wherein the preset condition for periodically releasing a local map comprises:
an amount of nodes in the pose graph reaches a second preset number; or
a moving distance of the autonomous mobile device reaches a preset distance; or
a duration from a start of constructing the pose graph to a current moment reaches a preset duration.

9. The map updating method according to claim 1, wherein obtaining, by aligning the global map with the local map, the target local map aligned with the global map, comprises:
determining a global sub-map in the global map, wherein a center of the global sub-map coincides with a center of the local map, and a size of the global sub-map is the same as a size of the local map;
extracting oriented fast and rotated brief (ORB) features of the local map as first features, and extracting ORB features of the global sub-map as second features; and
obtaining the local map aligned with the global map by aligning, based on the first features and the second feature, the global map with the local map.

10. The map updating method according to 9, wherein obtaining the local map aligned with the global map by aligning, based on the first features and the second feature, the global map with the local map, comprises:
acquiring image coordinates of the first features in the local map, and obtaining a first point cloud corresponding to the first features; acquiring image coordinates of the second features in the global sub-map, and obtaining a second point cloud corresponding to the second features;
determining an initial value for map alignment, based on the first features, the first point cloud, the second features, and the second point cloud; and
obtaining the local map aligned with the global map, by aligning, based on the initial value for map alignment, the global map and the local map with a cloud alignment algorithm.

11. The map updating method according to 10, wherein determining the initial value for map alignment based on the first features, the first point cloud, the second features, and the second point cloud, comprises:
obtaining, by performing feature matching between the first features and the second features, initial correspondences between the first features and the second features;
removing an outlier from the initial correspondences by using a discrete point removal algorithm, and calculating a transformation relationship between the first point cloud and the second point cloud, thereby obtaining correct correspondences between the first features and the second features and the transformation relationship between the first point cloud and the second point cloud;
in response to an amount of the correct correspondences being greater than a preset quantity, determining, as the initial value for map alignment, the transformation relationship between the first point cloud and the second point cloud; and
in response to the number of the correct correspondences being less than or equal to the preset quantity, determining the local map as the initial value for map alignment; and
wherein obtaining the local map aligned with the global map by aligning, based on the initial value for map alignment, the global map and the local map with the cloud alignment algorithm, comprises:
performing alignment on the initial value for map alignment by using the point cloud alignment algorithm, and obtaining an alignment result and a residual error;
in response to the residual error being less than a preset residual error, determining that the alignment is successful; and
obtaining the local map aligned with the global map, by performing, based on the alignment result, coordinate transformation on the local map.

12. The map updating method according to claim 1, wherein updating the global map based on the global map, the semantic map, and the target local map, comprises:
determining a change region in the target local map, based on the target local map, the global map, and the semantic map;
determining an update region in the change region, based on a distance of each grid cell in the change region in each of the target local map and the global map; and
updating a region corresponding to the update region in the global map, based on the update region in the target local map.

13. The map updating method according to claim 12, wherein determining the update region in the change region based on the distance of each grid cell in the change region in each of the target local map and the global map, comprises:
acquiring, as a first distance of each grid cell in the change region, a distance from the grid cell in the change region to a nearest obstacle in the target local map;
acquiring, as a second distance of each grid cell in the change region, a distance from a corresponding grid cell in a region corresponding to the change region to a nearest obstacle in the global map; and
determining the update region in the change region, based on the first distance and the second distance of each grid cell in the change region; and
wherein determining the update region in the change region based on the first distance and the second distance of each grid cell in the change region, comprises:
for each grid cell in the change region, taking this grid cell as a current grid cell, and calculating a likelihood value of change for the current grid cell based on the first distance and the second distance of the current grid cell; and
determining, as the update region, a region corresponding to a grid cell in the change region whose likelihood value is greater than a specified likelihood value.

14. The map updating method according to claim 12, wherein determining the change region based on the target local map, the global map, and the semantic map, comprises:
calculating, as an overlapping region of the target local map with the global map, an intersection of the target local map and the global map; and
determining the change region, based on a grid cell in the overlapping region and the semantic map; and
wherein determining the change region based on the grid cell in the overlapping region and the semantic map, comprises:
in response to detecting that a grid cell in the overlapping region is located in the dynamic region as labeled in the semantic map, determining, as the change region, the grid cell in the overlapping region that is located in the dynamic region as labeled in the semantic map.

15. The map updating method according to claim 12, wherein updating the corresponding region in the global map based on the update region in the target local map, comprises:
acquiring an occupancy state of each grid cell of the update region in the target local map, wherein the occupancy state comprises a known state and an unknown state;
determining, as a to-be-updated grid cell, each grid cell of the update region whose occupancy state is the known state, and determining, as an unchanged grid cell, each grid cell of the update region whose occupancy state is the unknown state;
updating a grid cell corresponding to the to-be-updated grid cell in the global map with the to-be-updated grid cell in the target local map; and
remaining a grid cell corresponding to the unchanged grid cell in the global map unchanged.

16. The map updating method according to claim 15, wherein each grid cell in the target local map further stores an occupancy probability of the grid cell, and before acquiring the occupancy state of each grid cell of the update region in the target local map, the method further comprises:
acquiring a preset unknown probability and the occupancy probability of each grid cell in the update region that is stored in the target local map; and
for each grid cell in the update region, taking this grid cell as a current grid cell, calculating a difference between the occupancy probability of the current grid cell and the preset unknown probability; in response to an absolute value of the difference corresponding to the current grid cell being less than a specified tolerance value, determining the occupancy state of the current grid cell as the unknown state; in response to the absolute value of the difference corresponding to the current grid cell being greater than or equal to the specified tolerance value, determining the occupancy state of the current grid cell as the known state.

17. The map updating method according to claim 1, wherein after acquiring the pre-constructed global map and before acquiring the semantic map, the method further comprises:
determining at least two preliminary dynamic regions from the global map by using at least two dynamic region determination methods, wherein one preliminary dynamic region is determined by each of the at least two dynamic region determination methods;
calculating, as the dynamic region, an intersection of the at least two preliminary dynamic regions; and
constructing the semantic map based on the dynamic region.

18. The map updating method according to claim 1, wherein after updating the global map based on the global map, the semantic map, and the target local map, the method further comprises:
constructing or updating a map database by storing an updated global map in the map database;
determining or updating the dynamic region in the semantic map based on the map database; and
in response to an error occurring during map update, restoring the global map to a historical global map last saved in the map database.

19. An autonomous mobile device, comprising a memory and a processor, wherein the memory stores an application program which, when being invoked by the processor, causes the processor to:
acquire a global map, a semantic map, and a pose and sensor data of an autonomous mobile device, wherein in the semantic map, a static region and a dynamic region of the global map are labeled;
periodically construct a local map based on the pose and the sensor data;
obtain, by aligning the global map with the local map, a target local map aligned with the global map; and
determine a change region in the target local map, based on the global map, the semantic map, and the target local map; and
update, based on the change region in the target local map, a region corresponding to the change region in the global map.

20. A non-transitory computer readable storage medium, wherein the computer readable storage medium stores program codes which, when being executed by a processor, cause the processor to execute a map updating method, comprising:
acquiring a pre-constructed global map, a semantic map, and a pose and sensor data of an autonomous mobile device, wherein in the semantic map, a static region and a dynamic region of the global map are labeled;
for each time a preset condition for periodically releasing a local map is met, constructing a local map based on the pose and the sensor data;
obtaining, by aligning the global map with the local map, a target local map aligned with the global map; and
updating the global map, based on the global map, the semantic map, and the target local map.
